(19) United States
(12) Patent Application Publication
(10) Pub. No.: US 2026/0220545 A1
(43) Pub. Date: Jul. 30, 2026

(54) DATA PROCESSING METHOD, DEVICE, AND STORAGE MEDIUM

(71) Applicants: China Mobile Communication Co., Ltd Research Institute, BEIJING (CN); CHINA MOBILE COMMUNICATIONS GROUP CO., LTD., BEIJING (CN)

(72) Inventors: Jingjing CHEN, BEIJING (CN); Xiaoran ZHANG, BEIJING (CN); Fang XIE, BEIJING (CN); Dan SONG, BEIJING (CN)

(21) Appl. No.: 19/629,584

(22) Filed: Mar. 26, 2026

Related U.S. Application Data
(63) Continuation of application No. PCT/CN2024/121739, filed on Sep. 27, 2024.

(30) Foreign Application Priority Data
Sep. 28, 2023 (CN) 202311278666.9

(51) Int. Cl. G06N 20/00

(52) U.S. Cl. CPC G06N 20/00

(57) ABSTRACT

A data processing method, a device, and a storage medium. The method is applied to a first device and includes at least one of the following: determining whether a first model satisfies a predefined requirement; performing updating or switching or activation or deactivation or fallback of the first model; and sending first information to a second device or a first node.

### CROSS-REFERENCE TO RELATED APPLICATIONS

The present application is a continuation-application of International (PCT) Patent Application No. PCT/CN2024/121739, filed on Sep. 27, 2024, which claims priority to Chinese Patent Application No. 202311278666.9 filed on Sep. 28, 2023, the entire contents of which are incorporated herein by reference.

### TECHNICAL FIELD

The present disclosure relates to the field of wireless communication technologies, and in particular, to a data processing method, a device, and a storage medium.

### BACKGROUND

Currently, the accuracy of Artificial Intelligence (AI) or Machine Learning (ML) models is affected by the environment. Taking an AI-based beam management model as an example, as objects move, if the beam management model is not updated, switched, or fallen back in a timely manner, the output optimal beam will be inaccurate. When the beam output by this model is used for UE reception, the receiving performance of the UE will be affected. When the output of this model is used by the network for downlink data transmission, the transmission of downlink data will be affected. However, related technologies do not involve how to determine the accuracy or performance of the current model output, or whether to perform model updates, switching, fallback, etc. Therefore, how to determine the accuracy or performance of the current model output, and whether to perform model updates, switching, fallback, etc., have become urgent technical problems to be solved.

### SUMMARY OF THE DISCLOSURE

Some embodiments of the present disclosure provide a data processing method, applied to a first device. The method includes at least one of the following:
determining whether a first model satisfies a predefined requirement;
performing updating or switching or activation or deactivation or fallback of the first model; and
sending first information to a second device or a first node.

Some embodiments of the present disclosure provide a first device, including a processor and a memory for storing a computer program executable on the processor,
wherein, the processor is configured to, when running the computer program, execute the method on the first device side according to any one of the above.

Some embodiments of the present disclosure provide a storage medium, storing a computer program; wherein the computer program, when executed by a processor of a first device, causes the first device to implement the method according to any one of the above.

### BRIEF DESCRIPTION OF THE DRAWINGS

FIG. 1 is a schematic diagram illustrating an implementation flow of a data processing method according to some embodiments of the present disclosure.

FIG. 2 is a schematic diagram illustrating a composition structure of a data processing apparatus according to some embodiments of the present disclosure.

FIG. 3 is a schematic diagram illustrating a composition structure of a first device according to some embodiments of the present disclosure.

### DETAILED DESCRIPTION

Before describing the technical solutions of the embodiments of the present disclosure, the related art is first explained.

In the related art, beam management based on an AI model may be understood as follows: a UE does not need to perform beam sweeping and measurement. Instead, a beam management model is obtained by training based on an AI algorithm combined with massive data. Based on this model, beam prediction in the spatial domain and/or time domain can be performed. The output can be used by the UE, for example, to assist the UE in determining which beam to use for downlink reception. The output can be used by the network side, for example, the UE sends the best one or more beams output by the AI model to a base station to assist the network in downlink data transmission (which may be understood as configuring a TCI-associated beam). It should be noted that the network side can also perform beam prediction to assist the network in configuring downlink data transmission.

The accuracy of an AI model is affected by the environment (the AI model may also be described as AI inference, which may be performed by the UE, by the network, or cooperatively by the UE and the network). As objects move, it is necessary to determine whether the current beam management model needs to be switched, updated, or fallen back. If the beam is not updated, switched, or fallen back in a timely manner, the output optimal beam will be inaccurate. When the beam output by this model is used for UE reception, the receiving performance of the UE will be affected. When the beam output by this model is used by the network for downlink transmission, the transmission of downlink data will be affected. The downlink data may refer to a Physical Downlink Shared Channel (PDSCH) or a Physical Downlink Control Channel (PDCCH). However, related technologies do not involve how to determine the performance of the current model output, or whether to perform model updates, switching, fallback, etc.

Based on this, in the embodiments of the present disclosure, a first device performs the following operations: determining whether a first model satisfies a predefined requirement; and/or, performing updating or switching or activation or deactivation or fallback of the first model; and/or, sending first information to a second device or a first node.

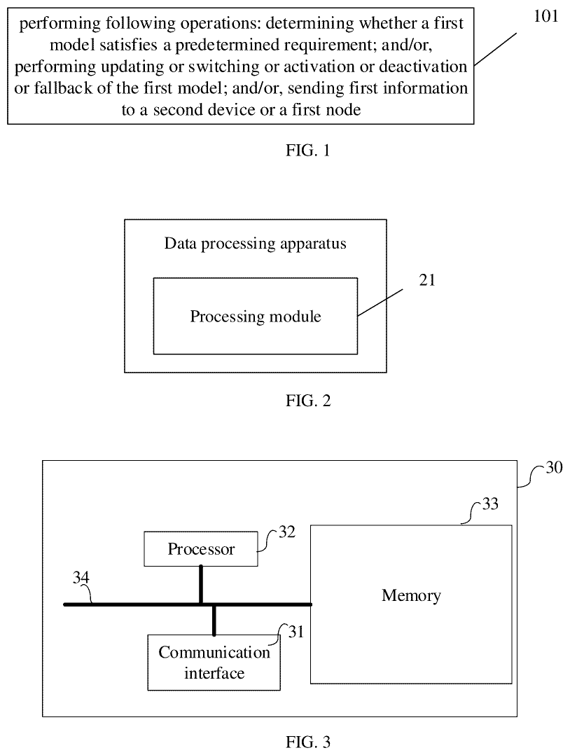

Referring to FIG. 1, FIG. 1 is a schematic diagram illustrating an implementation flow of a data processing method according to some embodiments of the present disclosure. The method may be applied to a first device. As shown in FIG. 1, the method includes the following operations at blocks.

At block 101: performing following operations: determining whether a first model satisfies a predefined requirement; and/or, performing updating or switching or activation or deactivation or fallback of the first model; and/or, sending first information to a second device or a first node.

As an example, the first device may include a UE, a network-side device, and the network-side device may refer to a base station, etc.

As an example, the second device includes a network-side device. The network-side device may refer to a base station, a core network, a network management system, etc., and may further include an AI/ML server.

Specifically, in a case where the second device is a network device or an AI-related server, this scenario is applicable to the network or server judging, deciding, and notifying the first device to perform updating or switching or activation or deactivation or fallback of the first model.

As an example, the first node may include an AI/ML execution node, an AI/ML training node. The first node here may also be described as a module or a link, for example, a training link or a data collection link of an AI model.

As an example, the first node may be an internal node of the first device, or a node of another device. A node of another device may be understood as a node that performs model training or executes a model.

As an example, in a case where the first device sends the first information to the first node or the second device, the model execution node, i.e., the first node or the second device, autonomously determines whether to perform updating or switching or activation or deactivation or fallback of the first model.

As an example, the operation of determining whether the first model satisfies the predefined requirement, and/or, performing updating or switching or activation or deactivation or fallback of the first model within a first time period, and/or, sending the first information to the second device or the first node, may be performed independently; or the determining operation may be performed in combination with the performing updating or switching or activation or deactivation or fallback and the sending the first information, respectively; or the above three operations may be performed in combination. For example, first performing the determination, then sending the first information, and finally performing updating or switching or activation or deactivation or fallback of the first model according to the first information. Specifically, the above may depend on the application scenario, for example, whether the model execution device autonomously determines the model's updating or switching or activation or deactivation or fallback, or whether another device is required to instruct the model execution device to perform the model's updating or switching or activation or deactivation or fallback.

As an example, the determining whether the first model satisfies the predefined requirement includes: the first device performing inference/prediction to infer/predict whether the performance of the first model satisfies the predefined requirement, i.e. the first device satisfies the predefined requirement. requirement can also be described as requirement or metric. Specifically, the inference/prediction includes at least one of beam prediction (e.g., the model output is a beam index), Reference Signal Receiving Power (RSRP) prediction (e.g., the model output is beam index RSRP), position prediction (e.g., the model output is a position), Precoding Matrix Indicator (PMI) prediction (e.g., the model output is PMI), and compressed PMI.

The predefined requirement includes at least one of the following:
a percentage/ratio of predicted TOP K beams that include a TOP1 beam is greater than or equal to a first threshold/first value, or described as a percentage/ratio of predicted K beams that include a strongest beam is greater than or equal to a first threshold/first value. Here, the predicted TOP K beams may also be described as predicted K beams, K is a non-zero integer; the TOP1 beam may be described as the best beam, and may also be described as the ground truth, or described as the strongest beam;
a percentage/ratio of the predicted beam being one of the Top K strongest beams is greater than or equal to a first threshold/first value, or it may also be described as a percentage/ratio of the predicted beam belonging to the Top K strongest beams is greater than or equal to a first threshold/first value;
a difference between a predicted RSRP and an ideal RSRP is less than or equal to a second threshold/second value; where, the ideal RSRP may also be described as the measured RSRP, or described as the ground truth;
a difference between a predicted RSRP of beam index i and an ideal RSRP of beam index i is less than or equal to a second threshold/second value; it should be noted that the scenario corresponding to this 0 is that the predicted RSRP and the ideal RSRP are for the same beam, i.e., for the same beam, the difference between its predicted RSRP and ideal RSRP is less than or equal to the second threshold/second value;
a difference between a predicted RSRP of beam index i and an ideal RSRP of beam index n is less than or equal to a second threshold/second value; it should be noted that the scenario corresponding to this requirement is that the predicted RSRP and the ideal RSRP may be for different beams. Further, beam index n is the index of the beam with the maximum predicted RSRP.

As an example, the determining whether the first model satisfies the predefined requirement may refer to determining whether an output of the first model is accurate, or, it may also be described as evaluating the performance of the first model.

As an example, the first model may include at least one of the following:
a beam management model;
a Channel State Information (CSI) feedback model; and
a positioning model.

The beam management includes: spatial beam prediction and temporal beam prediction; the CSI feedback includes CSI compression and CSI prediction; the positioning includes direct AI positioning and AI-assisted positioning.

As an example, the first model may refer to an AI/ML model.

As an example, the model may also be described as a functionality. For example, the first model may be described as a first functionality. The functionality may be understood as a configured enabled feature or feature group, and the configuration is based on the capability requirements of the UE.

The implementation process of the determining whether the first model satisfies the predefined requirement is described below in different cases.

First case: In practical application, by determining whether the first model satisfies the predefined requirement, the accuracy of the output of the first model may be determined; the determining whether the first model satisfies the predefined requirement may refer to determining, based on the output of the first model, whether the accuracy of the first model satisfies the predefined requirement. The first model satisfies the predefined requirement can be described as the first device satisfies the requirements. The accuracy of the first model satisfies the predefined requirement can be described as the first model satisfies the predefined accuracy requirement, i.e. the first device satisfies the accuracy requirements. Accuracy requirements can also be described as prediction requirements.

Based on this, in some embodiments, the determining whether the first model satisfies the predefined requirement includes the following.

In a case where a difference between an output of the first model and a first value is less than or equal to a predefined first threshold, determining that the accuracy of the first model satisfies the predefined requirement.

Or, in a case where a difference between the output of the first model and the first value is greater than or equal to a predefined first threshold, determining that the accuracy of the first model does not satisfy the predefined requirement.

Or, in a case where differences between M outputs of the first model and the first value are all less than or equal to a predefined first threshold, determining that the accuracy of the first model satisfies the predefined requirement.

Or, in a case where differences between M outputs of the first model and the first value are all greater than or equal to a predefined first threshold, determining that the accuracy of the first model does not satisfy the predefined requirement.

Or, in a case where a maximum value among K outputs of the first model is greater than or equal to a first value, determining that the accuracy of the first model satisfies the predefined requirement.

Or, in a case where a maximum value among K outputs of the first model is greater than or equal to a second value, determining that the accuracy of the first model satisfies the predefined requirement; where, the second value is a difference obtained by subtracting a predefined second threshold from the first value.

Or, in a case where a first count is greater than or equal to a predefined third threshold, determining that the accuracy of the first model satisfies the predefined requirement; where the first count represents a count of times that a maximum value among K outputs of the first model is greater than or equal to the first value.

Or, in a case where a ratio of the first count to a total number of model outputs is greater than or equal to a predefined fourth threshold, determining that the accuracy of the first model satisfies the predefined requirement.

Or, in a case where a second count is greater than or equal to a predefined fifth threshold, determining that the accuracy of the first model satisfies the predefined requirement; where the second count represents a count of times that a maximum value among K outputs of the first model is greater than or equal to the second value.

Or, in a case where a ratio of the second count to a total number of model outputs is greater than or equal to a predefined sixth threshold, determining that the accuracy of the first model satisfies the predefined requirement.

Or, in a case where an output of the first model is greater than or equal to the first value, determining that the accuracy of the first model satisfies the predefined requirement.

Or, in a case where an output of the first model is greater than or equal to the second value, determining that the accuracy of the first model satisfies the predefined requirement.

Or, in a case where a third count is greater than or equal to a predefined third threshold, determining that the accuracy of the first model satisfies the predefined requirement; where the third count represents a count of times that an output of the first model is greater than or equal to the first value.

Or, in a case where a ratio of the third count to a total number of model outputs is greater than or equal to the predefined fourth threshold, determining that the accuracy of the first model satisfies the predefined requirement.

Or, in a case where a fourth count is greater than or equal to a predefined fifth threshold, determining that the accuracy of the first model satisfies the predefined requirement; where the fourth count represents a count of times that an output of the first model is greater than or equal to the second value.

Or, in a case where a ratio of the fourth count to a total number of model outputs is greater than or equal to the predefined sixth threshold, determining that the accuracy of the first model satisfies the predefined requirement.

M and K are both integers greater than 1.

As an example, taking beam management as an example, the statement “in a case where a maximum value among K outputs of the first model is greater than or equal to the first value” may be understood that, when the maximum (or described as the highest) RSRP among the K beams output (or described as predicted) by the AI/ML model is greater than or equal to a certain RSRP threshold, the updating or switching or activation or deactivation or fallback of the first model is performed. The K outputs may also be described as the top K outputs. Specifically, the number of beams predicted by the model is L, L>=K, and the top K outputs may be understood as sorting the L beams in descending order of their values, and taking the first M beams from high to low.

As an example, “the maximum value among K outputs of the first model is greater than or equal to the second value, wherein the second value is a difference obtained by subtracting a predefined second threshold from the first value”, specifically, taking beam management as an example, it may be understood that, the maximum RSRP among the K beams output (or described as K predicted beams) is greater than or equal to a second value. The second value is a difference between second threshold and a first value. The second threshold is a certain RSRP. The first device needs to satisfy the requirement. If the requirement is not satisfied, the updating or switching or activation or deactivation or fallback of the first model is performed. The first value may be a RSRP measurement accuracy, a value greater than the RSRP measurement accuracy, or a value less than the RSRP measurement accuracy or a value in the unit of dB. The certain RSRP maybe the ground-truth RSRP, or described as ground-truth RSRP of the strongest genie-aided beam(s). The K outputs may also be described as the top K outputs, or described as top K predicted beams. The probability of the maximum value among K outputs of the first model is greater than or equal to the second value can also be considered as the requirement. Specifically, the number of beams predicted by the model is L, L>=K, and the top K outputs may be understood as sorting the L beams in descending order of their values, and taking the first M beams from high to low.

As an example, the accuracy of the first model satisfying the predefined requirement may also be described as the accuracy of the first model being high, or described as the performance of the first model being good. In this case, it indicates that the first model is working well and can continue to be used.

As an example, the accuracy of the first model not satisfying the predefined requirement may also be described as the accuracy of the first model being low, or described as the performance of the first model being poor. In this case, model switching is required (may be understood as conversing to or switching to other models), or deactivation is required (deactivation may be understood as not using the current first model), or model fallback is required (including falling back to non-AI/ML, i.e., not using the current first model, i.e., the AI/ML model), or activation of other models is required (activation or described as enabling), or model updating is required.

As an example, the output of the first model may also be described as a prediction of the first model.

As an example, in a case where the first model is a CSI feedback model, the output of the first model may include at least one of the following:
Precoding Matrix Indicator (PMI); and
channel impulse response.

As an example, in a case where the first model is a beam management model, the output of the first model may include at least one of the following:
beam index;
Reference Signal Receiving Power (RSRP); and
Signal to Interference plus Noise Ratio (SINR).

Here, RSRP may refer to L1-RSRP, and SINR may refer to L1-SINR.

As an example, in a case where the first model is a positioning model, the output of the first model may include at least one of the following:
position information;
Reference Signal Time Difference (RSTD);
transceiver time difference;
angle of arrival; and
angle of departure.

Here, the position information may include two-dimensional/three-dimensional position coordinates.

As an example, in a case where the first model is a CSI feedback model, the first value may include at least one of the following:
PMI; and
channel impulse response.

As an example, in a case where the first model is a beam management model, the first value may include at least one of the following:
beam index;
RSRP; and
SINR.

Here, RSRP may refer to L1-RSRP, and SINR may refer to L1-SINR.

As an example, in a case where the first model is a positioning model, the first value may include:
position information;
Reference Signal Time Difference (RSTD);
transceiver time difference;
angle of arrival; and
angle of departure.

Here, the position information may include two-dimensional/three-dimensional position coordinates.

As an example, the M outputs of the first model include consecutive M outputs of the first model. The main benefit is: this means may increase the robustness of the determination, i.e., by determining whether the outputs satisfy the predefined first threshold multiple times (M times) to determine the performance of the first model, which may avoid instability caused by a single comparison.

In some embodiments, the method further includes:
determining the first value by the following ways:
   setting the first value by a testing device; and/or,
   determining the first value through beam sweeping and/or measurement; and/or,
   determining the first value according to a reference signal in a TCI state.

As an example, the first value may also be described as an ideal value, or described as an actual situation, a true value. The performance (or described as generalization ability) of the model is determined by comparing the model's predicted output with the ideal value.

Specifically, in a test scenario, the ideal value is set by the testing device, for example, the index and/or RSRP of the best beam may be set. In a case where the output of the AI inference assists the UE in determining the downlink reception beam, the ideal value is the index and/or RSRP of the beam determined by the UE through beam sweeping and/or measurement in a non-AI scenario. In a case where the output of the AI inference assists the network in determining the downlink transmission beam, the ideal value is the beam actually used by the network for downlink data transmission, or described as a reference signal (resource RS) of the TCI, including the beam index and/or RSRP.

In some embodiments, the value of M is different for different reference symbols; and/or, the value of M is different for different scenarios.

As an example, the value of M may be configured by the network, or may be predefined in a protocol. Different values of M may be set based on different reference symbols and application scenarios.

Specifically, different values of M may be configured for different reference symbol types, which may refer to configuring different counters for a beam prediction model based on a Synchronization Signal Block (SSB) and a beam prediction model based on CSI-RS. Considering that compared to CSI-RS, the beam width of SSB is wider and the fault tolerance is higher, the value M of the counter configured for the SSB-based beam prediction model may be greater than the value M of the counter configured for the CSI-RS-based beam prediction model.

In addition, different values of M may be configured for different scenarios, which may refer to configuring different counters for a beam prediction model related to L3 (e.g., the target beam for handover) and a beam prediction model related to L1 (e.g., the beam for downlink transmission). Considering that beams for L3 have higher robustness requirements, the value M of the counter for the L3-related beam prediction model may be less than the value M of the counter for the L1-related beam prediction model.

In some embodiments, the method further includes:
configuring different threshold values for different reference symbols; and/or,
configuring different threshold values for different scenarios.

As an example, the value of the threshold may be configured by the network, or may be predefined in a protocol. Different threshold values may be set based on different reference symbols and application scenarios.

Specifically, configuring different threshold values for different reference symbol types may refer to configuring thresholds for the SSB-based beam prediction model and the CSI-RS-based beam prediction model respectively. Considering that compared to CSI-RS, the beam width of SSB is wider and the fault tolerance is higher, the threshold for the SSB-based beam prediction model may be higher than the threshold for the CSI-RS-based beam prediction model.

In addition, different threshold values may be configured for different scenarios, which may refer to configuring different thresholds for the L3-related beam prediction model (e.g., the target beam for handover) and the L1-related beam prediction model (e.g., the beam for downlink transmission). Considering that beams for L3 have higher robustness requirements, the evaluation threshold for the L3-related beam prediction model may be lower than the evaluation threshold for the L1-related beam prediction model.

Second case: In practical application, by determining whether the first model satisfies the predefined requirement, the performance of the output of the first model may be determined; the determining whether the first model satisfies the predefined requirement may also refer to evaluating the performance of the first model based on the output of the first model.

Based on this, in some embodiments, the determining whether the first model satisfies the predefined requirement includes the following.

In a case where a difference between an output of the first model and a first value is less than or equal to a predefined first threshold, determining that a performance level of the first model is a first performance level.

Or, in a case where the difference between the output of the first model and the first value is greater than or equal to a predefined P-th threshold and less than or equal to a predefined (P+1)-th threshold, determining that the performance level of the first model is a (P+1)-th performance level; where, P is an integer variable increasing from 1.

Or, in a case where the difference between the output of the first model and the first value is greater than or equal to a predefined R-th threshold and less than or equal to a predefined (R+1)-th threshold, determining that the performance level of the first model is an R-th performance level; where, R is an integer variable increasing from 1.

As an example, the first performance level may also be described as a first accuracy. The first performance level corresponds to a highest performance level.

For example, taking the first model as a beam management model and the difference as RSRP, in a case where the RSRP is less than or equal to a predefined first threshold, it is determined that the performance level of the beam management model is the first performance level; in a case where the RSRP is greater than or equal to the predefined first threshold and less than or equal to a predefined second threshold, it is determined that the performance level of the beam management model is a second performance level; in a case where the RSRP is greater than or equal to the predefined second threshold and less than or equal to a predefined third threshold, it is determined that the performance level of the beam management model is a third performance level, and so on.

In some embodiments, the method further includes:
determining the first value by the following ways:
   setting the first value by a testing device; and/or,
   determining the first value through beam sweeping and/or measurement; and/or,
   determining the first value according to a reference signal in a TCI state.

As an example, the first value may also be described as an ideal value, or described as an actual situation, a true value. The performance (or described as generalization ability) of the model is determined by comparing the model's predicted output with the ideal value.

Specifically, in a test scenario, the ideal value is set by the testing device. For example, the index and/or RSRP of the best beam may be set. In a case where the output of the AI inference assists the UE in determining the downlink reception beam, the ideal value is the index and/or RSRP of the beam determined by the UE through beam sweeping and/or measurement in a non-AI scenario. In a case where the output of the AI inference assists the network in determining the downlink transmission beam, the ideal value is the beam actually used by the network for transmitting downlink data, or described as a reference signal (resource RS) of the TCI, including the beam index and/or RSRP.

In some embodiments, the method further includes:
configuring different threshold values for different reference symbols; and/or,
configuring different threshold values for different scenarios.

As an example, the value of the threshold may be configured by the network, or may be predefined in a protocol. Different threshold values may be set based on different reference symbols and application scenarios.

Specifically, configuring different threshold values for different reference symbol types may refer to configuring thresholds for a beam prediction model based on a Synchronization Signal Block (SSB) and a beam prediction model based on CSI-RS respectively. Considering that compared to CSI-RS, the beam width of SSB is wider and the fault tolerance is higher, the threshold for the SSB-based beam prediction model may be higher than the threshold for the CSI-RS-based beam prediction model.

Furthermore, different threshold values may be configured for different scenarios, which may refer to configuring different thresholds for a beam prediction model related to L3 (e.g., the target beam for handover) and a beam prediction model related to L1 (e.g., the beam for downlink transmission). Considering that beams for L3 have higher robustness requirements, the evaluation threshold for the L3-related beam prediction model may be lower than the evaluation threshold for the L1-related beam prediction model.

Third case: In practical application, by determining whether the first model satisfies the predefined requirement, the accuracy of the output of the first model may be determined, or the performance of the first model may be determined. The determining whether the first model satisfies the predefined requirement may also refer to determining, based on a first probability or a first ratio, whether the accuracy of the first model satisfies the predefined requirement or evaluating a performance level of the first model.

Based on this, in some embodiments, the determining whether the first model satisfies the predefined requirement includes the following.

In a case where a first probability or a first ratio is greater than or equal to a predefined seventh threshold, determining that the accuracy of the first model satisfies the predefined requirement.

Or, in a case where the first probability or the first ratio is less than or equal to the predefined seventh threshold, determining that the accuracy of the first model does not satisfy the predefined requirement.

Or, in a case where the first probability or the first ratio is less than or equal to the predefined seventh threshold, determining that a performance level of the first model is a first performance level.

Or, in a case where the first probability or the first ratio is greater than or equal to a predefined Q-th threshold and less than or equal to a predefined (Q+1)-th threshold, determining that the performance level of the first model is a (Q+1)-th performance level; where, Q is an integer variable increasing from 1.

Or, in a case where the first probability or the first ratio is greater than or equal to a predefined S-th threshold and less than or equal to a predefined (S+1)-th threshold, determining that the performance level of the first model is an S-th performance level; where, S is an integer variable increasing from 1.

In some embodiments, the first probability or the first ratio includes:
the first probability, including:
a probability that an output of the first model is a first value; or, a probability that an output of the first model is correct; or, a probability that a difference between an output of the first model and a first value is less than or equal to a predefined first threshold;
the first ratio, including:
a ratio of a count of times that an output of the first model is a first value to a total number of model outputs; or, a ratio of a count of times that an output of the first model is correct to a total number of model outputs; or, a ratio of a count of times that a difference between an output of the first model and a first value is less than or equal to a predefined first threshold to a total number of model outputs.

In some embodiments, the probability that the output of the first model is the first value includes: a proportion of a count of times that the output of the first model is the first value to a total number of model outputs;
the probability that the output of the first model is correct includes: a proportion of a count of times that the output of the first model is correct to a total number of model outputs;
the probability that the difference between the output of the first model and the first value is less than or equal to the predefined first threshold includes: a proportion of a count of times that the difference between the output of the first model and the first value is less than or equal to the predefined first threshold to a total number of model outputs.

In some embodiments, the output of the first model being correct includes at least one of the following:
the output of the first model being the first value;
M outputs of the first model including the first value, where M is an integer greater than 1;
a beam index output by the first model being an index of an ideal beam;
a beam quality output by the first model being a true quality of the beam; and
at least one beam quality among N beam qualities output by the first model being the true quality of the beam, where N is an integer greater than 1.

In practical application, the first device may autonomously determine whether to perform updating or switching or activation or deactivation or fallback of the first model.

Based on this, in some embodiments, the performing updating or switching or activation or deactivation or fallback of the first model includes the following.

In a case where a difference between an output of the first model and a first value is greater than or equal to a predefined first threshold, performing updating or switching or activation or deactivation or fallback of the first model.

And/or, in a case where differences between M outputs of the first model and the first value are all greater than or equal to the predefined first threshold, performing updating or switching or activation or deactivation or fallback of the first model.

And/or, in a case where a maximum value among K outputs of the first model is less than or equal to the first value, performing updating or switching or activation or deactivation or fallback of the first model.

And/or, in a case where a maximum value among K outputs of the first model is less than or equal to a second value, performing updating or switching or activation or deactivation or fallback of the first model; where, the second value is a difference obtained by subtracting a predefined second threshold from the first value.

And/or, in a case where a first count is less than or equal to a predefined third threshold, performing updating or switching or activation or deactivation or fallback of the first model; where the first count represents a count of times that a maximum value among K outputs of the first model is greater than or equal to the first value.

And/or, in a case where a ratio of the first count to a total number of model outputs is less than or equal to a predefined fourth threshold, performing updating or switching or activation or deactivation or fallback of the first model.

And/or, in a case where a second count is less than or equal to a predefined fifth threshold, performing updating or switching or activation or deactivation or fallback of the first model; where the second count represents a count of times that a maximum value among K outputs of the first model is greater than or equal to the second value.

And/or, in a case where a ratio of the second count to a total number of model outputs is less than or equal to a predefined sixth threshold, performing updating or switching or activation or deactivation or fallback of the first model.

And/or, in a case where a first probability or a first ratio is less than or equal to a predefined seventh threshold, performing updating or switching or activation or deactivation or fallback of the first model.

M and K are both integers greater than 1.

As an example, the model switching includes switching from model 1 to model 2. The model activation includes switching from not using an AI/ML model to using an AI/ML model, or switching from model 1 to model 2, where model 2 may also be understood as being activated, and model 1 may be understood as being deactivated. The model fallback includes falling back to a non-AI/ML model. The main benefit is: as the channel environment changes, or the application scenario changes, or the parameter configuration changes, the performance of the model will also change. For example, the AI/ML model is no longer applicable (the performance of the current model is poor, e.g., below a certain threshold; or the performance of N consecutive models is poor, in which case the AI model cannot bring the corresponding gain, and it is more suitable to use a non-AI algorithm), or conversely, it can switch from a non-AI model to an AI model, or the current model is no longer applicable and other models are more suitable, etc. The model switching may be decided and executed by the first device (e.g., the first device is a UE, and this method involves the UE deciding whether to perform model updating); the model switching may be decided by another device or node, and the first device is notified via signaling (e.g., the first device is a UE, and the other device or node may be a base station, and this method involves the base station notifying the UE to perform model updating); the model switching may involve the first device sending its inclination to another device or node, which then decides and informs the first device via signaling (e.g., the first device is a UE, the other device or node may be a base station, and this method involves the UE notifying the network whether to perform model updating, the UE sends the information to the base station, and finally the base station instructs the UE to perform or not to perform model updating).

In some embodiments, the performing updating or switching or activation or deactivation or fallback of the first model includes:
performing updating or switching or activation or deactivation or fallback of the first model within a first time period.

As an example, the “performing updating or switching or activation or deactivation or fallback of the first model within a first time period” may be described as “completing updating or switching or activation or deactivation or fallback of the first model within a first time period”, or described as “the time taken by the first device to complete updating or switching or activation or deactivation or fallback of the first model does not exceed a first time period”.

Specifically, it may be that the time from receiving a message for model switching/activation/deactivation/fallback to completing the model switching/activation/deactivation/fallback does not exceed the first time period, or, the time from a requirement for model switching/activation/deactivation/fallback being met to completing the model switching/activation/deactivation/fallback does not exceed the first time period. The starting point of the first time period includes receiving a message for model switching/activation/deactivation/fallback, or the requirement for model switching/activation/deactivation/fallback being met. The first time period may be configured by the network, or may be predefined in a protocol. During the process of model switching/activation/deactivation/fallback, neither the new nor the old model may be usable. During this period, the AI/ML model cannot take effect. By using the first time period, a long delay for model switching/activation/deactivation/fallback may be avoided, thereby reducing the duration during which the AI/ML model is ineffective (or described as not working or applied), and improving system performance.

In practical application, the second device or the first node may decide whether to perform updating or switching or activation or deactivation or fallback of the first model, and notify the first device to perform updating or switching or activation or deactivation or fallback of the first model.

Based on this, in some embodiments, the sending the first information to the second device or the first node includes the following.

In a case where a difference between an output of the first model and a first value is greater than or equal to a predefined first threshold, sending the first information to the second device or the first node.

And/or, in a case where differences between M outputs of the first model and the first value are all greater than or equal to the predefined first threshold, sending the first information to the second device or the first node.

And/or, in a case where a first probability or a first ratio is less than or equal to a predefined seventh threshold, sending the first information to the second device or the first node.

And/or, in a case where the difference between the output of the first model and the first value is greater than or equal to a predefined P-th threshold and less than or equal to a predefined (P+1)-th threshold, sending the first information to the second device or the first node; where, P is an integer variable increasing from 1.

And/or, in a case where the first probability or the first ratio is greater than or equal to a predefined Q-th threshold and less than or equal to a predefined (Q+1)-th threshold, sending the first information to the second device or the first node; where, Q is an integer variable increasing from 1.

And/or, in a case where a maximum value among K outputs of the first model is less than or equal to the first value, sending the first information to the second device or the first node.

And/or, in a case where a maximum value among K outputs of the first model is less than or equal to a second value, sending the first information to the second device or the first node.

And/or, in a case where a first count is less than or equal to a predefined third threshold, sending the first information to the second device or the first node; where the first count represents a count of times that a maximum value among K outputs of the first model is greater than or equal to the first value.

And/or, in a case where a ratio of the first count to a total number of model outputs is less than or equal to a predefined fourth threshold, sending the first information to the second device or the first node.

And/or, in a case where a second count is less than or equal to a predefined fifth threshold, sending the first information to the second device or the first node; where the second count represents a count of times that a maximum value among K outputs of the first model is greater than or equal to the second value.

And/or, in a case where a ratio of the second count to a total number of model outputs is less than or equal to a predefined sixth threshold, sending the first information to the second device or the first node.

M and K are both integers greater than 1.

In some embodiments, the first information contains at least one of the following:
the accuracy of the first model satisfying the predefined requirement;
the accuracy of the first model not satisfying the predefined requirement;
an indication of switching of the first model;
an indication of fallback of the first model;
an indication of activation of the first model;
an indication of deactivation of the first model; and
a model index.

As an example, the first information containing “the accuracy of the first model satisfying the predefined requirement” and “the accuracy of the first model not satisfying the predefined requirement” is mainly applied in scenarios where the second device or the first node determines and decides whether to instruct switching, activation, deactivation, or fallback of the first model based on the accuracy information of the first model. The first information including “an indication of switching, activation, deactivation, or fallback of the first model” is mainly applied in scenarios where the first device directly feeds back suggestions/inclinations for model processing to the second device or the first node. The model index includes an index of a target model for switching, an index of a source model for switching, an index of a model to be activated, and an index of a model to be deactivated.

In some embodiments, the method further includes:
configuring different threshold values for different reference symbols; and/or,
configuring different threshold values for different scenarios.

As an example, the value of the threshold may be configured by the network, or may be predefined in a protocol. Different threshold values may be set based on different reference symbols and application scenarios.

Specifically, configuring different threshold values for different reference symbol types may refer to configuring thresholds for a beam prediction model based on SSB and a beam prediction model based on CSI-RS respectively. Considering that compared to CSI-RS, the beam width of SSB is wider and the fault tolerance is higher, the threshold for the SSB-based beam prediction model may be higher than the threshold for the CSI-RS-based beam prediction model.

Furthermore, different threshold values may be configured for different scenarios, which may refer to configuring different thresholds for a beam prediction model related to L3 (e.g., the target beam for handover) and a beam prediction model related to L1 (e.g., the beam for downlink transmission). Considering that beams for L3 have higher robustness requirements, the evaluation threshold for the L3-related beam prediction model may be lower than the evaluation threshold for the L1-related beam prediction model.

In some embodiments, the first value is determined by the following ways:
setting the first value by a testing device; and/or,
determining the first value through beam sweeping and/or measurement; and/or,
determining the first value according to a reference signal in a TCI state.

In some embodiments, for different reference signals, the value of M is different; and/or, for different scenarios, the value of M is different.

In some embodiments, the method further includes:
receiving second information sent by the second device;
where, the second information contains at least one of the following:
   an indication of model updating;
   an indication of model fallback;
   an indication of model activation;
   an indication of model deactivation;
   an indication of model switching; and
   a model index.

In some embodiments, the receiving second information sent by a second device includes:
receiving the second information sent by the second device, and performing at least one of the following operations:
activating a model;
deactivating a model;
switching a model;
updating a model;
falling back a model; and
training a model.

As an example, the first device performs model activation, deactivation, switching, updating, or fallback according to the second information. In a case where the second information does not contain a beam index, the first device autonomously determines a target model.

In some embodiments, the method further includes:
performing at least one of the following operations:
   in a case where the first model satisfies the predefined requirement, not performing the model updating or switching or activation or deactivation or fallback;
   in a case where the first model does not satisfy the predefined requirement, performing the model updating or switching or activation or deactivation or fallback;
   in a case where the first model satisfies the predefined requirement, not sending the first information to the second device or the first node;
   in a case where the first model does not satisfy the predefined requirement, sending the first information to the second device or the first node.

In the embodiments of the present disclosure, the following advantages are provided.
(1) On one hand, by determining whether the first model satisfies the predefined requirement, the accuracy or performance of the current model output can be determined; on the other hand, updating or switching or activation or deactivation or fallback of the first model can be performed autonomously.
(2) First information is sent to the second device or the first node, such that the second device or the first node decides whether the first device should perform updating or switching or activation or deactivation or fallback of the first model.

That is to say, the accuracy or performance of the first model, such as a beam management model, is evaluated to obtain an evaluation result. Based on the evaluation result, relevant information is fed back to the second device or the first node to assist the first device in determining whether to perform model updating, switching, fallback, etc.

To implement the data processing method of the embodiments of the present disclosure, the embodiments of the present disclosure further provide a data processing apparatus, configured in a first device. FIG. 2 is a schematic diagram of a composition structure of a data processing apparatus according to some embodiments of the present disclosure. As shown in FIG. 2, the apparatus includes:
a processing module 21, configured to perform following operations: determining whether a first model satisfies a predefined requirement; and/or, performing updating or switching or activation or deactivation or fallback of the first model; and/or, sending first information to a second device or a first node.

In some embodiments, the processing module 21 is further configured to perform the following.

In a case where a difference between an output of the first model and a first value is less than or equal to a predefined first threshold, determining that the accuracy of the first model satisfies the predefined requirement.

Or, in a case where a difference between the output of the first model and the first value is greater than or equal to a predefined first threshold, determining that the accuracy of the first model does not satisfy the predefined requirement.

Or, in a case where differences between M outputs of the first model and the first value are all less than or equal to a predefined first threshold, determining that the accuracy of the first model satisfies the predefined requirement.

Or, in a case where differences between M outputs of the first model and the first value are all greater than or equal to a predefined first threshold, determining that the accuracy of the first model does not satisfy the predefined requirement.

Or, in a case where a maximum value among K outputs of the first model is greater than or equal to a first value, determining that the accuracy of the first model satisfies the predefined requirement.

Or, in a case where a maximum value among K outputs of the first model is greater than or equal to a second value, determining that the accuracy of the first model satisfies the predefined requirement; where, the second value is a difference obtained by subtracting a predefined second threshold from the first value.

Or, in a case where a first count is greater than or equal to a predefined third threshold, determining that the accuracy of the first model satisfies the predefined requirement; where the first count represents a count of times that a maximum value among K outputs of the first model is greater than or equal to the first value.

Or, in a case where a ratio of the first count to a total number of model outputs is greater than or equal to a predefined fourth threshold, determining that the accuracy of the first model satisfies the predefined requirement.

Or, in a case where a second count is greater than or equal to a predefined fifth threshold, determining that the accuracy of the first model satisfies the predefined requirement; where the second count represents a count of times that a maximum value among K outputs of the first model is greater than or equal to the second value.

Or, in a case where a ratio of the second count to a total number of model outputs is greater than or equal to a predefined sixth threshold, determining that the accuracy of the first model satisfies the predefined requirement.

Or, in a case where an output of the first model is greater than or equal to the first value, determining that the accuracy of the first model satisfies the predefined requirement.

Or, in a case where an output of the first model is greater than or equal to the second value, determining that the accuracy of the first model satisfies the predefined requirement.

Or, in a case where a third count is greater than or equal to a predefined third threshold, determining that the accuracy of the first model satisfies the predefined requirement; where the third count represents a count of times that an output of the first model is greater than or equal to the first value.

Or, in a case where a ratio of the third count to a total number of model outputs is greater than or equal to the predefined fourth threshold, determining that the accuracy of the first model satisfies the predefined requirement.

Or, in a case where a fourth count is greater than or equal to a predefined fifth threshold, determining that the accuracy of the first model satisfies the predefined requirement; where the fourth count represents a count of times that an output of the first model is greater than or equal to the second value.

Or, in a case where a ratio of the fourth count to a total number of model outputs is greater than or equal to the predefined sixth threshold, determining that the accuracy of the first model satisfies the predefined requirement.

M and K are both integers greater than 1.

In some embodiments, the processing module 21 is further configured to perform the following.

In a case where a difference between an output of the first model and a first value is less than or equal to a predefined first threshold, determining that a performance level of the first model is a first performance level.

Or, in a case where the difference between the output of the first model and the first value is greater than or equal to a predefined P-th threshold and less than or equal to a predefined (P+1)-th threshold, determining that the performance level of the first model is a (P+1)-th performance level; where, P is an integer variable increasing from 1.

Or, in a case where the difference between the output of the first model and the first value is greater than or equal to a predefined R-th threshold and less than or equal to a predefined (R+1)-th threshold, determining that the performance level of the first model is an R-th performance level; where, R is an integer variable increasing from 1.

In some embodiments, the processing module 21 is further configured to perform the following.

In a case where a first probability or a first ratio is greater than or equal to a predefined seventh threshold, determining that the accuracy of the first model satisfies the predefined requirement.

Or, in a case where the first probability or the first ratio is less than or equal to the predefined seventh threshold, determining that the accuracy of the first model does not satisfy the predefined requirement.

Or, in a case where the first probability or the first ratio is less than or equal to the predefined seventh threshold, determining that a performance level of the first model is a first performance level.

Or, in a case where the first probability or the first ratio is greater than or equal to a predefined Q-th threshold and less than or equal to a predefined (Q+1)-th threshold, determining that the performance level of the first model is a (Q+1)-th performance level; where, Q is an integer variable increasing from 1.

Or, in a case where the first probability or the first ratio is greater than or equal to a predefined S-th threshold and less than or equal to a predefined (S+1)-th threshold, determining that the performance level of the first model is an S-th performance level; where, S is an integer variable increasing from 1.

In some embodiments, the processing module 21 is further configured to perform the following.

In a case where a difference between an output of the first model and a first value is greater than or equal to a predefined first threshold, performing updating or switching or activation or deactivation or fallback of the first model.

And/or, in a case where differences between M outputs of the first model and the first value are all greater than or equal to the predefined first threshold, performing updating or switching or activation or deactivation or fallback of the first model.

And/or, in a case where a maximum value among K outputs of the first model is less than or equal to the first value, performing updating or switching or activation or deactivation or fallback of the first model.

And/or, in a case where a maximum value among K outputs of the first model is less than or equal to a second value, performing updating or switching or activation or deactivation or fallback of the first model; where, the second value is a difference obtained by subtracting a predefined second threshold from the first value.

And/or, in a case where a first count is less than or equal to a predefined third threshold, performing updating or switching or activation or deactivation or fallback of the first model; where the first count represents a count of times that a maximum value among K outputs of the first model is greater than or equal to the first value.

And/or, in a case where a ratio of the first count to a total number of model outputs is less than or equal to a predefined fourth threshold, performing updating or switching or activation or deactivation or fallback of the first model.

And/or, in a case where a second count is less than or equal to a predefined fifth threshold, performing updating or switching or activation or deactivation or fallback of the first model; where the second count represents a count of times that a maximum value among K outputs of the first model is greater than or equal to the second value.

And/or, in a case where a ratio of the second count to a total number of model outputs is less than or equal to a predefined sixth threshold, performing updating or switching or activation or deactivation or fallback of the first model.

And/or, in a case where a first probability or a first ratio is less than or equal to a predefined seventh threshold, performing updating or switching or activation or deactivation or fallback of the first model.

M and K are both integers greater than 1.

In some embodiments, the processing module 21 is further configured to perform the following.
performing updating or switching or activation or deactivation or fallback of the first model within a first time period.

In some embodiments, the processing module 21 is further configured to perform the following.

In a case where a difference between an output of the first model and a first value is greater than or equal to a predefined first threshold, sending the first information to the second device or the first node.

And/or, in a case where differences between M outputs of the first model and the first value are all greater than or equal to the predefined first threshold, sending the first information to the second device or the first node.

And/or, in a case where a first probability or a first ratio is less than or equal to a predefined seventh threshold, sending the first information to the second device or the first node.

And/or, in a case where the difference between the output of the first model and the first value is greater than or equal to a predefined P-th threshold and less than or equal to a predefined (P+1)-th threshold, sending the first information to the second device or the first node; where, P is an integer variable increasing from 1.

And/or, in a case where the first probability or the first ratio is greater than or equal to a predefined Q-th threshold and less than or equal to a predefined (Q+1)-th threshold, sending the first information to the second device or the first node; where, Q is an integer variable increasing from 1.

And/or, in a case where a maximum value among K outputs of the first model is less than or equal to the first value, sending the first information to the second device or the first node.

And/or, in a case where a maximum value among K outputs of the first model is less than or equal to a second value, sending the first information to the second device or the first node.

And/or, in a case where a first count is less than or equal to a predefined third threshold, sending the first information to the second device or the first node; where the first count represents a count of times that a maximum value among K outputs of the first model is greater than or equal to the first value.

And/or, in a case where a ratio of the first count to a total number of model outputs is less than or equal to a predefined fourth threshold, sending the first information to the second device or the first node.

And/or, in a case where a second count is less than or equal to a predefined fifth threshold, sending the first information to the second device or the first node; where the second count represents a count of times that a maximum value among K outputs of the first model is greater than or equal to the second value.

And/or, in a case where a ratio of the second count to a total number of model outputs is less than or equal to a predefined sixth threshold, sending the first information to the second device or the first node.

M and K are both integers greater than 1.

In some embodiments, the first information contains at least one of the following:
the accuracy of the first model satisfying the predefined requirement;
the accuracy of the first model not satisfying the predefined requirement;
an indication of switching of the first model;
an indication of fallback of the first model;
an indication of activation of the first model;
an indication of deactivation of the first model; and
a model index.

In some embodiments, the first probability includes:
a probability that an output of the first model is a first value; or, a probability that an output of the first model is correct; or, a probability that a difference between an output of the first model and a first value is less than or equal to a predefined first threshold;
the first ratio includes:
a ratio of a count of times that an output of the first model is a first value to a total number of model outputs; or, a ratio of a count of times that an output of the first model is correct to a total number of model outputs; or, a ratio of a count of times that a difference between an output of the first model and a first value is less than or equal to a predefined first threshold to a total number of model outputs.

In some embodiments, the probability that the output of the first model is the first value includes: a proportion of a count of times that the output of the first model is the first value to a total number of model outputs;
the probability that the output of the first model is correct includes: a proportion of a count of times that the output of the first model is correct to a total number of model outputs;
the probability that the difference between the output of the first model and the first value is less than or equal to the predefined first threshold includes: a proportion of a count of times that the difference between the output of the first model and the first value is less than or equal to the predefined first threshold to a total number of model outputs.

In some embodiments, the output of the first model being correct includes at least one of the following:
the output of the first model being the first value;
M outputs of the first model including the first value, where M is an integer greater than 1;
a beam index output by the first model being an index of an ideal beam;
a beam quality output by the first model being a true quality of the beam; and
at least one beam quality among N beam qualities output by the first model being the true quality of the beam, where N is an integer greater than 1.

In some embodiments, the apparatus is further configured to perform:
configuring different threshold values for different reference symbols; and/or,
configuring different threshold values for different scenarios.

In some embodiments, the apparatus is further configured to perform:
determining the first value by the following ways:
   setting the first value by a testing device; and/or,
   determining the first value through beam sweeping and/or measurement; and/or,
   determining the first value according to a reference signal in a TCI state.

In some embodiments, for different reference symbols, the value of M is different; and/or, for different scenarios, the value of M is different.

In some embodiments, the apparatus is further configured to perform:
receiving second information sent by the second device or the first node;
where, the second information contains at least one of the following:
   an indication of model updating;
an indication of model fallback;
   an indication of model activation;
   an indication of model deactivation;
   an indication of model switching; and
   a model index.

In some embodiments, the apparatus is further configured to perform:
receiving the second information sent by the second device or the first node, and performing at least one of the following operations:
activating a model;
deactivating a model;
switching a model;
updating a model;
falling back a model; and
training a model.

In some embodiments, the apparatus is further configured to perform:
performing at least one of the following operations:
   in a case where the first model satisfies the predefined requirement, not performing the model updating or switching or activation or deactivation or fallback;
   in a case where the first model does not satisfy the predefined requirement, performing the model updating or switching or activation or deactivation or fallback;
   in a case where the first model satisfies the predefined requirement, not sending the first information to the second device or the first node;
   in a case where the first model does not satisfy the predefined requirement, sending the first information to the second device or the first node.

In practical application, the processing module 21 may be implemented by a processor in the data processing apparatus.

It should be noted that when the data processing apparatus provided in the above embodiments performs data processing, it is only described by way of example with the division of the above program modules. In practical applications, the above processing may be assigned to different program modules as needed, that is, the internal structure of the apparatus is divided into different program modules to complete all or part of the processing described above. In addition, the data processing apparatus provided in the above embodiments and the data processing method embodiments belong to the same concept. For the specific implementation process, reference may be made to the method embodiments, which will not be repeated herein.

The embodiments of the present disclosure further provide a first device. As shown in FIG. 3, the first device includes:
a communication interface 31, capable of exchanging information with other devices; and
a processor 32, connected to the communication interface 31, configured to, when running a computer program, execute the method provided by one or more technical solutions on the first device side described above. The computer program is stored in a memory 33.

It should be noted that the specific processing process of the processor 32 and the communication interface 31 is detailed in the method embodiments and will not be repeated herein.

Of course, in practical application, various components of the first device 30 are coupled together through a bus system 34. It is understood that the bus system 34 is configured to implement connection communication between these components. The bus system 34 includes not only a data bus, but also a power bus, a control bus, and a status signal bus. However, for clarity, all buses are labeled as the bus system 34 in FIG. 3.

The memory 33 in the embodiments of the present disclosure is configured to store various types of data to support the operation of the first device 30. Examples of such data include: any computer program for operating on the first device 30.

The method disclosed in the above embodiments of the present disclosure can be applied to the processor 32 or implemented by the processor 32. The processor 32 may be an integrated circuit chip with signal processing capability. In the implementation process, each step of the above method can be completed by the integrated logic circuit of hardware in the processor 32 or instructions in the form of software. The above processor 32 may be a general-purpose processor, a digital signal processor (DSP), or other programmable logic devices, discrete gate or transistor logic devices, discrete hardware components, etc. The processor 32 can implement or execute the methods, steps, and logic block diagrams disclosed in the embodiments of the present disclosure. The general-purpose processor may be a microprocessor or any conventional processor. Combining the steps of the method disclosed in the embodiments of the present disclosure, it can be directly embodied as being executed and completed by a hardware decoding processor, or executed and completed by a combination of hardware and software modules in the decoding processor. The software module may be located in a storage medium, and the storage medium is located in the memory 33. The processor 32 reads information in the memory 33 and completes the steps of the aforementioned method in combination with its hardware.

In an exemplary embodiment, the first device 30 may be implemented by one or more Application Specific Integrated Circuits (ASICs), DSPs, Programmable Logic Devices (PLDs), Complex Programmable Logic Devices (CPLDs), Field-Programmable Gate Arrays (FPGAs), general-purpose processors, controllers, Microcontroller Units (MCUs), microprocessors, or other electronic components to execute the aforementioned method.

It is understood that the memory (e.g. the memory 33) in the embodiments of the present disclosure may be volatile memory or non-volatile memory, or may include both volatile and non-volatile memory. Among them, the non-volatile memory may be Read-Only Memory (ROM), Programmable Read-Only Memory (PROM), Erasable Programmable Read-Only Memory (EPROM), Electrically Erasable Programmable Read-Only Memory (EEPROM), ferromagnetic random access memory (FRAM), flash memory, magnetic surface memory, optical disk, or Compact Disc Read-Only Memory (CD-ROM); magnetic surface memory may be disk memory or tape memory. Volatile memory may be Random Access Memory (RAM), which is used as external high-speed cache. By way of example but not limitation, many forms of RAM are available, such as Static Random Access Memory (SRAM), Synchronous Static Random Access Memory (SSRAM), Dynamic Random Access Memory (DRAM), Synchronous Dynamic Random Access Memory (SDRAM), Double Data Rate Synchronous Dynamic Random Access Memory (DDRSDRAM), Enhanced Synchronous Dynamic Random Access Memory (ESDRAM), SyncLink Dynamic Random Access Memory (SLDRAM), and Direct Rambus Random Access Memory (DRRAM). The memory described in the embodiments of the present disclosure is intended to include, but is not limited to, these and any other suitable types of memory.

In an exemplary embodiment, the embodiments of the present disclosure further provide a storage medium, namely a computer storage medium, specifically a computer-readable storage medium, for example, a memory including a stored computer program. The above computer program can be executed by the processor 32 of the first device 30 to complete the steps described in the aforementioned method on the first device side. The computer-readable storage medium may be FRAM, ROM, PROM, EPROM, EEPROM, Flash Memory, magnetic surface memory, optical disk, CD-ROM, or other memory.

It should be noted that terms like “first” and “second” are configured to distinguish similar objects and do not necessarily imply a specific order or sequence.

In addition, the technical solutions recorded in the embodiments of the present disclosure may be combined arbitrarily without conflict.

The above description is only some embodiments of the present disclosure and is not intended to limit the scope of the present disclosure.

What is claimed is:

1. A data processing method, applied to a first device; wherein the method comprises at least one of the following:
determining whether a first model satisfies a predefined requirement;
performing updating or switching or activation or deactivation or fallback of the first model; and
sending first information to a second device or a first node.

2. The method according to claim 1, wherein the determining whether a first model satisfies a predefined requirement comprises:
in a case where a difference between an output of the first model and a first value is less than or equal to a predefined first threshold, determining that an accuracy of the first model satisfies the predefined requirement; or,
in a case where the difference between the output of the first model and the first value is greater than or equal to the predefined first threshold, determining that the accuracy of the first model does not satisfy the predefined requirement; or,
in a case where differences between M outputs of the first model and the first value are all less than or equal to the predefined first threshold, determining that the accuracy of the first model satisfies the predefined requirement; or,
in a case where differences between the M outputs of the first model and the first value are all greater than or equal to the predefined first threshold, determining that the accuracy of the first model does not satisfy the predefined requirement; or,
in a case where a maximum value among K outputs of the first model is greater than or equal to the first value, determining that the accuracy of the first model satisfies the predefined requirement; or,
in a case where a maximum value among the K outputs of the first model is greater than or equal to a second value, determining that the accuracy of the first model satisfies the predefined requirement; wherein, the second value is a difference obtained by subtracting a predefined second threshold from the first value; or,
in a case where a first count is greater than or equal to a predefined third threshold, determining that the accuracy of the first model satisfies the predefined requirement; wherein the first count represents a count of times that a maximum value among K outputs of the first model is greater than or equal to the first value; or,
in a case where a ratio of the first count to a total number of model outputs is greater than or equal to a predefined fourth threshold, determining that the accuracy of the first model satisfies the predefined requirement; or,
in a case where a second count is greater than or equal to a predefined fifth threshold, determining that the accuracy of the first model satisfies the predefined requirement; wherein the second count represents a count of times that a maximum value among K outputs of the first model is greater than or equal to the second value; or,
in a case where a ratio of the second count to a total number of model outputs is greater than or equal to a predefined sixth threshold, determining that the accuracy of the first model satisfies the predefined requirement; or,
in a case where the output of the first model is greater than or equal to the first value, determining that the accuracy of the first model satisfies the predefined requirement; or,
in a case where the output of the first model is greater than or equal to the second value, determining that the accuracy of the first model satisfies the predefined requirement; or,
in a case where a third count is greater than or equal to a predefined third threshold, determining that the accuracy of the first model satisfies the predefined requirement; wherein the third count represents a count of times that an output of the first model is greater than or equal to the first value; or,
in a case where a ratio of the third count to a total number of model outputs is greater than or equal to a predefined fourth threshold, determining that the accuracy of the first model satisfies the predefined requirement; or,
in a case where a fourth count is greater than or equal to a predefined fifth threshold, determining that the accuracy of the first model satisfies the predefined requirement; wherein the fourth count represents a count of times that an output of the first model is greater than or equal to the second value; or,
in a case where a ratio of the fourth count to a total number of model outputs is greater than or equal to a predefined sixth threshold, determining that the accuracy of the first model satisfies the predefined requirement;
wherein, M and K are both integers greater than 1.

3. The method according to claim 1, wherein the determining whether a first model satisfies a predefined requirement comprises:
in a case where a difference between an output of the first model and a first value is less than or equal to a predefined first threshold, determining that a performance level of the first model is a first performance level; or,
in a case where a difference between an output of the first model and a first value is greater than or equal to a predefined P-th threshold and less than or equal to a predefined (P+1)-th threshold, determining that a performance level of the first model is a (P+1)-th performance level; wherein, P is an integer variable increasing from 1; or,
in a case where a difference between an output of the first model and a first value is greater than or equal to a predefined R-th threshold and less than or equal to a predefined (R+1)-th threshold, determining that a performance level of the first model is an R-th performance level; wherein, R is an integer variable increasing from 1.

4. The method according to claim 1, wherein the determining whether a first model satisfies a predefined requirement comprises:
in a case where a first probability or a first ratio is greater than or equal to a predefined seventh threshold, determining that an accuracy of the first model satisfies the predefined requirement; or,
in a case where a first probability or a first ratio is less than or equal to a predefined seventh threshold, determining that an accuracy of the first model does not satisfy the predefined requirement; or,
in a case where a first probability or a first ratio is less than or equal to a predefined seventh threshold, determining that a performance level of the first model is a first performance level; or,
in a case where a first probability or a first ratio is greater than or equal to a predefined Q-th threshold and less than or equal to a predefined (Q+1)-th threshold, determining that a performance level of the first model is a (Q+1)-th performance level; wherein, Q is an integer variable increasing from 1; or,
in a case where a first probability or a first ratio is greater than or equal to a predefined S-th threshold and less than or equal to a predefined (S+1)-th threshold, determining that a performance level of the first model is an S-th performance level; wherein, S is an integer variable increasing from 1.

5. The method according to claim 1, wherein the performing updating or switching or activation or deactivation or fallback of the first model comprises at least one of the following:
in a case where a difference between an output of the first model and a first value is greater than or equal to a predefined first threshold, performing the updating or switching or activation or deactivation or fallback of the first model;
in a case where differences between M outputs of the first model and the first value are all greater than or equal to the predefined first threshold, performing the updating or switching or activation or deactivation or fallback of the first model;
in a case where a maximum value among K outputs of the first model is less than or equal to the first value, performing the updating or switching or activation or deactivation or fallback of the first model;
in a case where a maximum value among K outputs of the first model is less than or equal to a second value, performing the updating or switching or activation or deactivation or fallback of the first model; wherein, the second value is a difference obtained by subtracting a predefined second threshold from the first value;
in a case where a first count is less than or equal to a predefined third threshold, performing the updating or switching or activation or deactivation or fallback of the first model; wherein the first count represents a count of times that a maximum value among K outputs of the first model is greater than or equal to the first value;
in a case where a ratio of the first count to a total number of model outputs is less than or equal to a predefined fourth threshold, performing the updating or switching or activation or deactivation or fallback of the first model;
in a case where a second count is less than or equal to a predefined fifth threshold, performing the updating or switching or activation or deactivation or fallback of the first model; wherein the second count represents a count of times that a maximum value among K outputs of the first model is greater than or equal to the second value;
in a case where a ratio of the second count to a total number of model outputs is less than or equal to a predefined sixth threshold, performing the updating or switching or activation or deactivation or fallback of the first model; and
in a case where a first probability or a first ratio is less than or equal to a predefined seventh threshold, performing the updating or switching or activation or deactivation or fallback of the first model;
wherein, M and K are both integers greater than 1.

6. The method according to claim 1, wherein the performing updating or switching or activation or deactivation or fallback of the first model comprises:
performing the updating or switching or activation or deactivation or fallback of the first model within a first time period.

7. The method according to claim 1, wherein the sending first information to a second device or a first node comprises at least one of the following:
in a case where a difference between an output of the first model and a first value is greater than or equal to a predefined first threshold, sending the first information to the second device or the first node;
in a case where differences between M outputs of the first model and the first value are all greater than or equal to the predefined first threshold, sending the first information to the second device or the first node;
in a case where a first probability or a first ratio is less than or equal to a predefined seventh threshold, sending the first information to the second device or the first node;
in a case where a difference between an output of the first model and the first value is greater than or equal to a predefined P-th threshold and less than or equal to a predefined (P+1)-th threshold, sending the first information to the second device or the first node; wherein, P is an integer variable increasing from 1;
in a case where a first probability or a first ratio is greater than or equal to a predefined Q-th threshold and less than or equal to a predefined (Q+1)-th threshold, sending the first information to the second device or the first node; wherein, Q is an integer variable increasing from 1;
in a case where a maximum value among K outputs of the first model is less than or equal to the first value, sending the first information to the second device or the first node;
in a case where a maximum value among K outputs of the first model is less than or equal to a second value, sending the first information to the second device or the first node; wherein, the second value is a difference obtained by subtracting a predefined second threshold from the first value;
in a case where a first count is less than or equal to a predefined third threshold, sending the first information to the second device or the first node; wherein the first count represents a count of times that a maximum value among K outputs of the first model is greater than or equal to the first value;
in a case where a ratio of the first count to a total number of model outputs is less than or equal to a predefined fourth threshold, sending the first information to the second device or the first node;
in a case where a second count is less than or equal to a predefined fifth threshold, sending the first information to the second device or the first node; wherein the second count represents a count of times that a maximum value among K outputs of the first model is greater than or equal to the second value; and
in a case where a ratio of the second count to a total number of model outputs is less than or equal to a predefined sixth threshold, sending the first information to the second device or the first node;
wherein, M and K are both integers greater than 1.

8. The method according to claim 7, wherein the first information contains at least one of the following:
an accuracy of the first model satisfying the predefined requirement;
an accuracy of the first model not satisfying the predefined requirement;
an indication of switching of the first model;
an indication of fallback of the first model;
an indication of activation of the first model;
an indication of deactivation of the first model; and
a model index.

9. The method according to claim 4, wherein,
the first probability comprises:
a probability that an output of the first model is a first value; or, a probability that an output of the first model is correct; or, a probability that a difference between an output of the first model and a first value is less than or equal to a predefined first threshold;
the first ratio comprises:
a ratio of a count of times that an output of the first model is a first value to a total number of model outputs; or, a ratio of a count of times that an output of the first model is correct to a total number of model outputs; or, a ratio of a count of times that a difference between an output of the first model and a first value is less than or equal to a predefined first threshold to a total number of model outputs.

10. The method according to claim 9, wherein,
the probability that the output of the first model is the first value comprises: a proportion of a count of times that the output of the first model is the first value to a total number of model outputs;
the probability that the output of the first model is correct comprises: a proportion of a count of times that the output of the first model is correct to a total number of model outputs;
the probability that the difference between the output of the first model and the first value is less than or equal to the predefined first threshold comprises: a proportion of a count of times that the difference between the output of the first model and the first value is less than or equal to the predefined first threshold to a total number of model outputs.

11. The method according to claim 9, wherein the output of the first model being correct comprises at least one of the following:
the output of the first model being the first value;
M outputs of the first model comprising the first value, wherein, M is an integer greater than 1;
a beam index output by the first model being an index of an ideal beam;
a beam quality of a beam output by the first model being a true quality of the beam; and
at least one beam quality among N beam qualities output by the first model being the true quality of a corresponding beam, wherein, N is an integer greater than 1.

12. The method according to claim 2, further comprising at least one of the following:
configuring different threshold values for different reference symbols; and
configuring different threshold values for different scenarios.

13. The method according to claim 2, further comprising:
determining the first value by at least one of the following:
setting the first value by a testing device;
determining the first value through at least one of beam sweeping and measurement; and
determining the first value according to a reference signal in a Transmission Configuration Indication (TCI) state.

14. The method according to claim 2, wherein at least one of the following is satisfied:
for different reference symbols, a value of M is different; and
for different scenarios, a value of M is different.

15. The method according to claim 1, further comprising:
receiving second information sent by the second device or the first node;
wherein, the second information contains at least one of the following:
an indication of model updating;
an indication of model fallback;
an indication of model activation;
an indication of model deactivation;
an indication of model switching; and
a model index.

16. The method according to claim 15, wherein the receiving second information sent by the second device or the first node comprises:
receiving the second information sent by the second device or the first node, and performing at least one of the following operations:
model activation;
model deactivation;
model switching;
model updating;
model fallback; and
model training.

17. The method according to claim 1, further comprises at least one of the following operations:
in a case where the first model satisfies the predefined requirement, not performing model updating or model switching or model activation or model deactivation or model fallback;
in a case where the first model does not satisfy the predefined requirement, performing model updating or model switching or model activation or model deactivation or model fallback;
in a case where the first model satisfies the predefined requirement, not sending the first information to the second device or the first node; and
in a case where the first model does not satisfy the predefined requirement, sending the first information to the second device or the first node.

18. A first device, comprising a processor and a memory for storing a computer program executable on the processor,
wherein, the processor is configured to, when running the computer program, perform at least one of the following:
determining whether a first model satisfies a predefined requirement;
performing updating or switching or activation or deactivation or fallback of the first model; and
sending first information to a second device or a first node.

19. The first device according to claim 18, wherein the determining whether a first model satisfies a predefined requirement comprises:
in a case where a difference between an output of the first model and a first value is less than or equal to a predefined first threshold, determining that an accuracy of the first model satisfies the predefined requirement; or,
in a case where the difference between the output of the first model and the first value is greater than or equal to the predefined first threshold, determining that the accuracy of the first model does not satisfy the predefined requirement; or,
in a case where differences between M outputs of the first model and the first value are all less than or equal to the predefined first threshold, determining that the accuracy of the first model satisfies the predefined requirement; or,
in a case where differences between the M outputs of the first model and the first value are all greater than or equal to the predefined first threshold, determining that the accuracy of the first model does not satisfy the predefined requirement; or,
in a case where a maximum value among K outputs of the first model is greater than or equal to the first value, determining that the accuracy of the first model satisfies the predefined requirement;
or,
in a case where a maximum value among the K outputs of the first model is greater than or equal to a second value, determining that the accuracy of the first model satisfies the predefined requirement; wherein, the second value is a difference obtained by subtracting a predefined second threshold from the first value; or,
in a case where a first count is greater than or equal to a predefined third threshold, determining that the accuracy of the first model satisfies the predefined requirement; wherein the first count represents a count of times that a maximum value among K outputs of the first model is greater than or equal to the first value; or,
in a case where a ratio of the first count to a total number of model outputs is greater than or equal to a predefined fourth threshold, determining that the accuracy of the first model satisfies the predefined requirement; or,
in a case where a second count is greater than or equal to a predefined fifth threshold, determining that the accuracy of the first model satisfies the predefined requirement; wherein the second count represents a count of times that a maximum value among K outputs of the first model is greater than or equal to the second value; or,
in a case where a ratio of the second count to a total number of model outputs is greater than or equal to a predefined sixth threshold, determining that the accuracy of the first model satisfies the predefined requirement; or,
in a case where the output of the first model is greater than or equal to the first value, determining that the accuracy of the first model satisfies the predefined requirement; or,
in a case where the output of the first model is greater than or equal to the second value, determining that the accuracy of the first model satisfies the predefined requirement; or,
in a case where a third count is greater than or equal to a predefined third threshold, determining that the accuracy of the first model satisfies the predefined requirement; wherein the third count represents a count of times that an output of the first model is greater than or equal to the first value; or,
in a case where a ratio of the third count to a total number of model outputs is greater than or equal to a predefined fourth threshold, determining that the accuracy of the first model satisfies the predefined requirement; or,
in a case where a fourth count is greater than or equal to a predefined fifth threshold, determining that the accuracy of the first model satisfies the predefined requirement; wherein the fourth count represents a count of times that an output of the first model is greater than or equal to the second value; or,
in a case where a ratio of the fourth count to a total number of model outputs is greater than or equal to a predefined sixth threshold, determining that the accuracy of the first model satisfies the predefined requirement;
wherein, M and K are both integers greater than 1.

20. A non-transitory computer-readable storage medium, storing a computer program; wherein the computer program, when executed by a processor of a first device, causes the first device to perform at least one of the following:
determining whether a first model satisfies a predefined requirement;
performing updating or switching or activation or deactivation or fallback of the first model; and
sending first information to a second device or a first node.
